(19) United States
(12) Patent Application Publication
(10) Pub. No.: US 2004/0205002 A1
(43) Pub. Date: Oct. 14, 2004

(54) System and method for enabling more informed relationship decisions

(75) Inventor: Mark Christopher Layton, Long Beach, CA (US)

Correspondence Address: The Law Office of Deepti Panchawagh-Jain, 3039 Calle De Las Estrella, San Jose, CA, 95148, US

(73) Assignee: Platinum Edge, Inc., Long Beach, CA (US)

(21) Appl. No.: 10/458,161

(22) Filed: Jun. 9, 2003

Related U.S. Application Data
(60) Provisional application No. 60/462,150, filed on Apr. 10, 2003.

(51) Int. Cl. G06F 17/60

(52) U.S. Cl. 705/26

(57) ABSTRACT

A system and method for collecting, processing, and distributing information for purposes of establishing more informed decisions in initiating and/or participating in relationships. In one embodiment, on-line facilitation sites partner with a verification site which, upon authorization, obtains and/or verifies information, and updates an individual's profile on the partner sites with an indication of verification of the information. In one embodiment, a partner site is not needed, and the verification site can itself host the individual's verified information. In yet another embodiment, the facilitation site may be physical, and in such cases, the required information is obtained/verified, and the individual is provided with an indication of the verification.

### CROSS-REFERENCE TO RELATED APPLICATIONS

This application claims the benefit of U.S. Provisional Patent Application Serial No. 60/462,150, entitled “System and Method for Enabling More Informed Relationship Decisions”, by inventor Mark Layton, filed on Apr. 10, 2003, which subject matter is incorporated herein by reference in its entirety.

### BACKGROUND OF THE INVENTION

1. Field of the Invention

This invention relates generally to disseminating information, and more specifically to collecting, processing, and distributing information for purposes of establishing more informed decisions in initiating and/or participating in relationships.

2. Description of the Related Art

In recent years, establishing relationships with people has become faster and more convenient due to the increased use of the Internet, emails, phones, faxes, and so on. However, because establishing of such relationships frequently involves interaction with people without any known references/intermediaries, it is increasingly difficult to make informed decisions about these relationships.

The natures of the relationships that people may seek to initiate and maintain can vary broadly. Such relationships include, but are not limited to, social relationships, employment relationships, other business/corporate relationships, etc.

Several “facilitation sites” for meeting people for the purposes of social interaction exist. Such facilitation sites can be physical (e.g., bars, dance clubs, etc.), or can be on-line (e.g., over the Internet, over email lists, etc.). There are several on-line dating and/or match-making services. Some of these are Match.com™, Yahoo!™ Dating, Yahoo!™ Personals, Lavalife™, AOL™ Dating, etc. Most of these services allow the user to provide a profile of himself where the person can indicate his gender, age, and location. Numerous such profiles for various users become part of a database. When another user is seeking a suitable match on such a service, that user can specify the gender preference, age range, location, etc. that she would prefer. The various profiles on the database are searched to pull up suitable matches.

Several of these interaction facilitation sites share the common factor that they often facilitate interaction between people who neither know each other personally, nor through common acquaintances. One of the dangers of initiating interactions with strangers or acquaintances is that there is little assurance upfront as to whether the information provided by a stranger is indeed accurate and true, or whether the stranger is engaging in misrepresentation. This problem is even more exaggerated in the context of online dating. For instance, in the case of online dating, often one does not even know where the person lives, or what the person on the other end of the network looks like. Even in cases where photographs are provided, there is little assurance as to whether the person in the photograph is indeed the person one is communicating with. People looking for potential matches would feel much more comfortable if they could be assured of some degree of confidence in the information they were receiving. Some kind of indication that the information provided by a potential match has been verified, would provide such confidence.

Another problem with initiating interaction with strangers is that it is difficult to obtain information on some delicate matters before knowing a person very well, which information may, nonetheless, be very important. For instance, information related to the health of an individual (e.g., test results for Human Immunodeficiency Virus (HIV) and other Sexually Transmitted Diseases (STDs), when the tests were conducted, etc.) about a potential match is often very relevant in the context of social interaction. Such information is especially important in light of the fact that about 40,000 new cases of HIV are recorded each year.

In most of the currently existing online dating services, health related information is not included as a criterion on which a search can be premised. In other words, while a user can specify that her potential matches be a certain gender, a certain age range, and a certain location, a user cannot specify, for example, that her potential matches “have tested for HIV within the last 6 months and have tested negative.” Although several sites exist for meeting people who are diagnosed with various STDs (e.g., www.HIVdate.com: a website for people with HIV or AIDS, www.stifriends.com: online dating for people with STDS), there is little assurance that a person's representation that he is STD/HIV free is accurate, and to determine when he was tested. In addition, several times such information is not provided in the user profile at all.

Thus, there is a need for a method and system which can verify and/or obtain certain types of information in the context of initiating and maintaining relationships. In addition, there is a need for a method and system which can indicate which information has been verified.

### SUMMARY OF THE INVENTION

In accordance with the present invention, information is obtained and/or verified, processed, and updated, to enable more informed decisions in initiating and/or participating in relationships.

In one embodiment of the present invention, an individual uses a partner site (an online facilitation site) to provide a profile containing information about herself. This profiled individual then provides authorization to a verification site in accordance with the present invention, to verify some portion of the provided information, and/or to obtain some specified information. If specified information is obtained, the individual's profile is then updated to include the obtained information. In addition, an indication is provided within the profile that the information is independently obtained. If some portion of the provided information is verified, the individual's profile is updated to indicate that some portions of the profile have been verified. Other individuals searching for suitable matches and viewing the profiled individual's profile can then see these indications. In one embodiment, it is possible for the verification site to partner with several different facilitation sites. In such situations, the individual's profile may be updated on several different partner sites to indicate that certain information has been obtained/verified.

In another embodiment of the present invention, an individual can directly access a site in accordance with an embodiment of the present invention, without going through a partner site. For example, the individual may directly provide the site with information to be verified and/or obtained, and a profile including the verified and/or obtained information may be hosted on the site itself

In one embodiment, the online profile of the individual may be updated continually, at pre-specified time intervals. In one embodiment, the profile gets updated when a re-verification (or new verification/obtaining) request is submitted by the profiled individual.

In yet another embodiment of the present invention, such verification/obtaining of information may be at a physical site. For example, in one embodiment, an area is set up in the vicinity of a dance club, where people can get tested for HIV. Once the result is obtained, the individuals get an indication of their HIV status (e.g., a bracelet), which also includes some identification of the individual (e.g., a photograph).

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWING

The invention has other advantages and features which will be more readily apparent from the following detailed description of the invention and the appended claims, when taken in conjunction with the accompanying drawings, in which:

FIG. 1 is a block diagram of a system in accordance with an embodiment of the present invention;

FIG. 2A is a screen shot illustrating a profiled individual's profile on a partner site;

FIG. 2B is a screen shot illustrating how verified information may be reflected in a profiled individual's profile on a partner site in accordance with an embodiment of the present invention;

FIG. 2C is another screen shot illustrating how verified information may be reflected in a profiled individual's profile on a partner site in accordance with an embodiment of the present invention;

FIG. 3 is a block diagram of a system in accordance with an embodiment of the present invention;

FIG. 4 is a screen shot illustrating data for a profiled individual on the verification site in accordance with an embodiment of the present invention;

FIG. 5A is a block diagram of the verification site.

FIG. 5B is a flowchart illustrating the functioning of the verification site in accordance with an embodiment of the present invention;

FIG. 6 is a flowchart illustrating how, in accordance with an embodiment of the present invention, information may be obtained and certified at a physical location.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

The figures depict a preferred embodiment of the present invention for purposes of illustration only. It is noted that similar or like reference numbers in the figures may indicate similar or like functionality. One of skill in the art will readily recognize from the following discussion that alternative embodiments of the structures and methods disclosed herein may be employed without departing from the principles of the invention(s) herein. For purposes of readability, pronouns such as he and she, his and hers, him and her, etc. are used interchangeably. It is to be understood that regardless of the specific pronoun used, the various embodiments of the present invention are applicable to both genders.

For purposes of discussion, the following description focuses on embodiments of the present invention in the context of social interaction. It will, however, be obvious to one with skill in the art that the present invention is not limited to social interaction. Rather, a system and method in accordance with the present invention can be used for enabling more informed decisions pertaining to several different kinds of relationships. For instance, one example of such a relationship is an employment relationship, where a system in accordance with an embodiment of the present invention can be used to verify whether a potential employee really has the educational credentials she claims. Some other examples of information which may be verifiable in the context of employment relationships include the criminal background, address, professional certifications, and work experience of a potential employee.

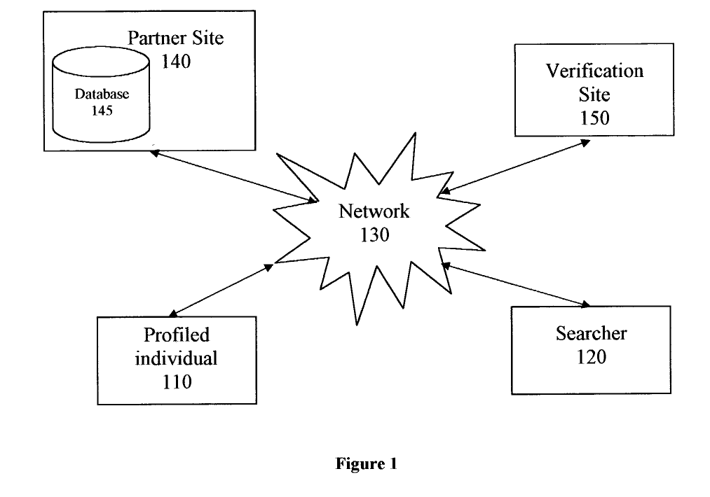

FIG. 1 is a block diagram of a system 100 in accordance with one embodiment of the present invention. System 100 is an on-line social interaction system, and comprises a profiled individual 110, a searcher 120, a network 130, a partner site 140, and a verification site 150. System 100 makes it possible for different people to provide information about themselves, as well as to request verification of provided information and/or obtaining of additional specified information. Indicators of such verification make people searching for matches aware of what information has been verified.

Profiled individuals 110 and searchers 120 are both people desirous of establishing and/or maintaining social contact. A profiled individual 110 is any person who provides his/her information to create a “profile” on some information storage system (e.g., a database). A “profile” includes any set of information relating to the profiled individual 110. In one embodiment, the database is accessible from the partner site 140. In one embodiment, the database 145 may be on the partner site 140 itself. In other embodiments, the database 145 may not be on the partner site 140, but rather the partner site 140 may simply link to databases on some other site. The profile information can include various kinds of personal information, such as gender, geographical location, age, physical characteristics, lifestyle choices, etc. Sometimes such information also includes characteristics (e.g., genotype preferences, phenotype preferences, etc.) desirable in a person that the profiled individual 110 would like to socialize with. In addition, such information may include the health status of the profiled individual 110. For instance, the profiled individual 110 may authorize his/her profile to include when he/she was last tested for HIV and/or other STDs (e.g., gonorrhea, syphilis, Chlamydia, herpes, etc.), what the results were, and so on. Other examples of information that may be included in a person's profile include income level, education level, and/or criminal background. Still further examples include information relating to diseases to which one might be genetically predisposed (e.g., Tay-Sachs, Huntington's, breast cancer, hemophilia, sickle cell disease, etc.), and/or phenotype information (e.g., physical characteristics such as color of eyes, color/textures of hair, height, figure, etc.). Any such information in the individual's profile may be verified. This will be discussed in further detail with reference to the verification site 150.

Searchers 120 are people who search the database 145 accessible from the partner site 140 for potential matches, by entering certain criteria that they find desirable in people that they may want to socialize with. In order to find suitable matches, such criteria are checked against the profiles provided by the profiled individuals 110. In some embodiments of the present invention, a searcher 120 can search for suitable matches based on criterion such as her potential matches “have tested for HIV within the last 6 months and have tested negative.”

It will be obvious to one of ordinary skill in the art that there may be an overlap amongst profiled individuals 110 and searchers 120, since people who provide their own information for online databases often, in addition, also search the online database for potential matches.

In one embodiment, profiled individuals 110 and searchers 120 both communicate with the partner site 140 and the verification site 150 over the network 130. In addition, in one embodiment, the verification site 150 communicates with the partner site 140 over the network 130. It is to be noted that the network 130 may be used for any part of, or the entirety of, these communications. Other modes of communication between these various entities can include, but are not limited to, phone, fax, mail, etc.

The network 130 is any type of network such as a wide area network (WAN) or a local area network (LAN). The wide area network may include the Internet, the Internet 2, and the like. The local area network may include an Intranet, which may be a network based on, for example, TCP/IP belonging to an organization accessible only by the organization's members, employees, or others with authorization. The local area network may also be a network such as, for example, Netware™ from Novell Corporation (Provo, Utah) or Windows NT from Microsoft Corporation (Redmond, Wash.).

The partner site 140 is any web-site which facilitates establishing and/or maintaining of relationships. Some examples of social interaction facilitation sites are on-line dating or match-making type service sites such as Match.com™, Yahoo!™ Dating, Lavalife™, AOL™ Dating, Yahoo!™ Personals, etc. Examples of partner sites in the employment context include Hotjobs.com, Monster.com, etc.

In the prior art, searchers 120 had little assurance that the information provided by a profiled individual 110 was accurate. As social relationships got established and/or progressed, the people involved generally had to take the information provided by the profiled individual 110 at face value and trust that the person providing it was being honest. In an on-line situation, where people are often interacting with strangers, it is often difficult to put faith in the trust relationship alone. In addition, it is often difficult to broach sensitive subjects (e.g., HIV testing, etc.) with a potential match.

In accordance with one embodiment of the present invention, system 100 includes a verification site 150. This verification site 150 can, in one embodiment, verify information provided by profiled individuals 110. In one embodiment, the verification site 150 can obtain additional information about the profiled individuals 110. In yet another embodiment, the verification site 150 can provide some sort of link to a reference who will verify information (e.g., the name and contact information of a doctor who will verify health-related test results, as well as a message from the doctor that the results have been verified). Alternately, the verification site 150 can automatically link to a verification that the reference has provided.

The verification/obtaining would be subsequent to an authorization provided by the profiled individual 110. For instance, if the profiled individual were to provide his geographical location, and an authorization to verify the same, the verification site 150 would employ means to verify this geographical location. Alternately, the profiled individual could simply authorize the verification site 150 to obtain his geographical location, and the verification site 150 would obtain this information.

Another example of information that may be verified by the verification site 150 is information related to the health status of the profiled individual 110. For instance, in one embodiment, the profiled individual 110 provides information in his/her profile relating to when and where he was last tested for HIV and/or other STDs. In addition, the profiled individual 110 registers with the verification site 150, and provides it with authorization to verify that the tests were indeed conducted at the specified time and place, and to obtain the results. In one embodiment, the profiled individual 110 also provides payment for the verification. The verification site 150 then obtains information regarding the testing date and place, and cross-checks these with the information provided by the profiled individual 110. Further, the verification site 150 obtains the test results. It will be obvious to one skilled in the art that any or all of the relevant information could either be provided by the profiled individual 110, and then verified by the verification site 150, or be simply obtained by the verification site 110.

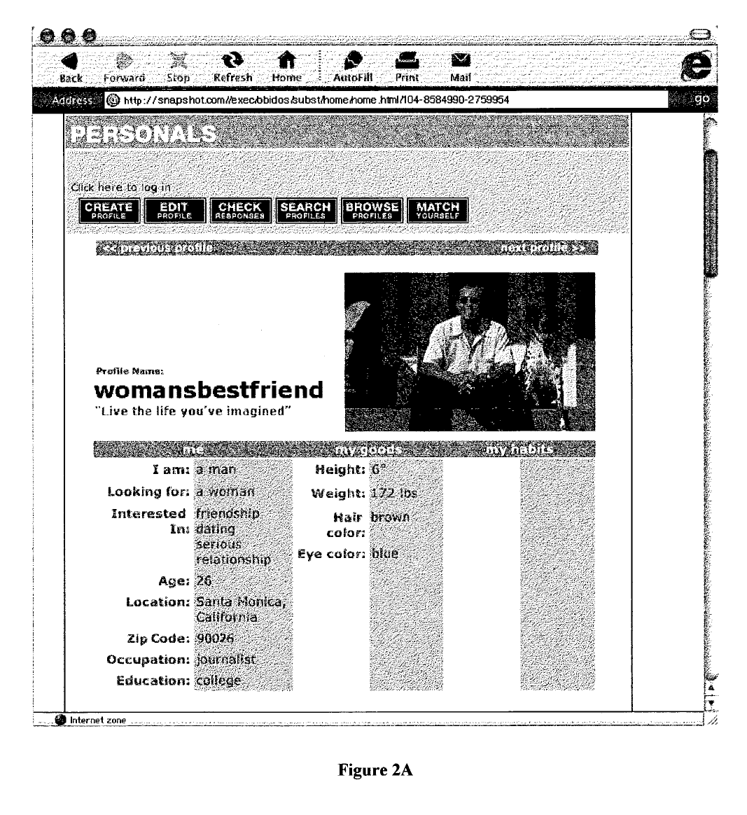

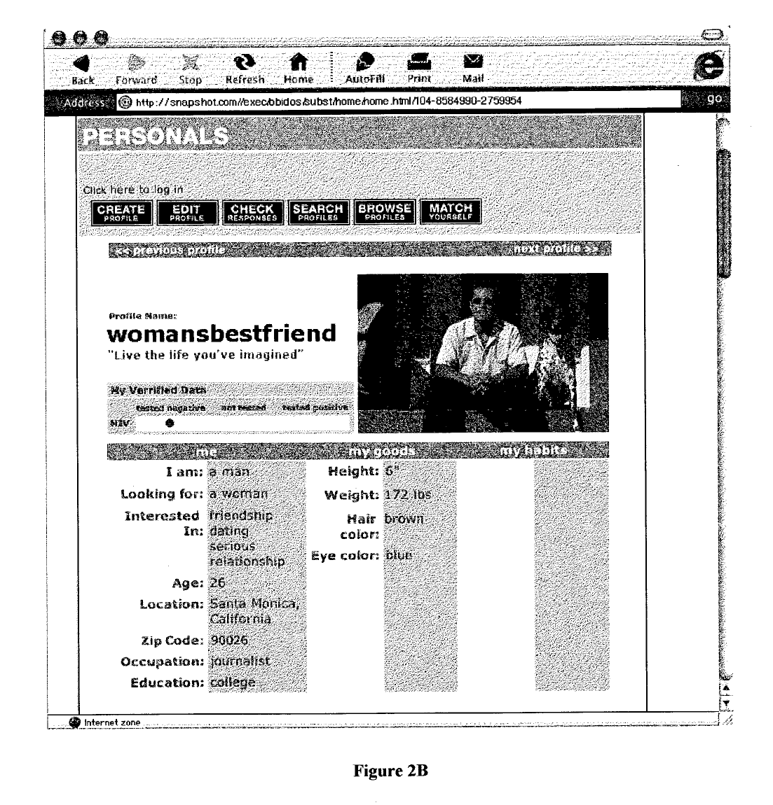

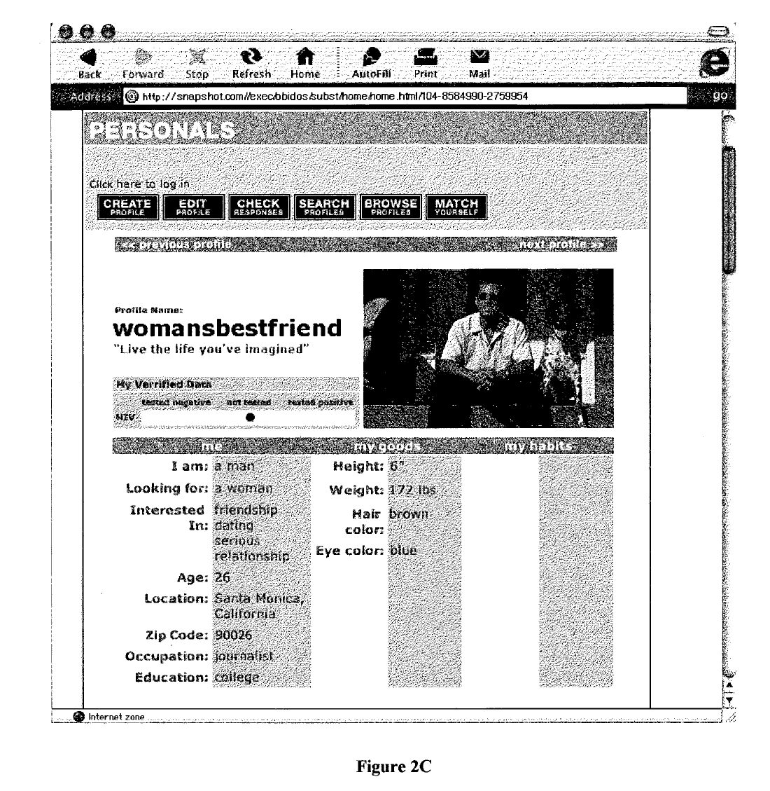

In one embodiment, once the specified information has been verified/obtained, the profiled individual's 110 profile in the partner site 140 is updated to reflect an indication of the verification. FIG. 2A illustrates what a profile on one possible partner site may look like conventionally. FIGS. 2B and 2C are screen shots illustrating how verification of information may be indicated in a profiled individual's 110 profile on the partner site in one embodiment. FIG. 2B illustrates a case where it has been verified that the profiled individual 110 has tested negative for HIV. In one embodiment, this is indicated by a green dot under the heading “tested negative”. FIG. 2C illustrates a case where the profiled individual 110 has not tested for HIV. In one embodiment, this is indicated by an orange dot under the heading “not tested”. In FIGS. 2B & 2C, the verification indication appears at the beginning of the profile. It is to be noted that FIGS. 2B & 2C illustrate just one embodiment, and that the appearance of the profile, as well as the indicators of verification may look different. For example, a verification indicator may appear beside each piece of information on the profile. As another example, the date of verification may also be included. Moreover, in one embodiment, the updated profile including verification indicators may be hosted on the partner site 140 itself. In another embodiment, the updated profile including verification indicators may be hosted on the verification site 150, and its contents may be framed into the partner site 140. In yet another embodiment, the updated profile including verification indicators may be hosted on any other site.

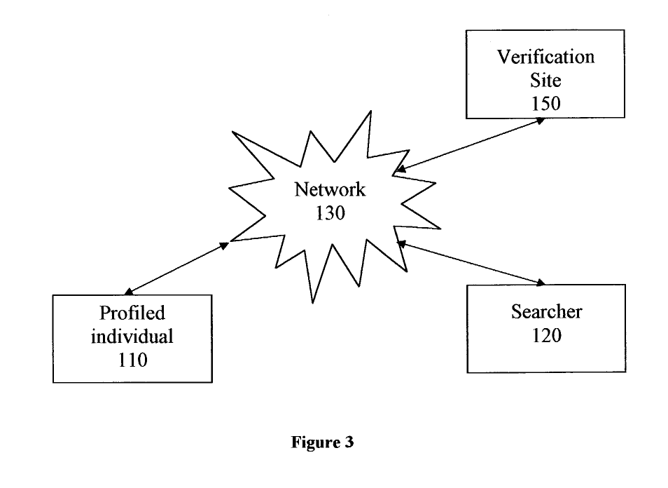

FIG. 3 illustrates a system in accordance with another embodiment of the present invention. System 300 comprises a profiled individual 110, a searcher 120, a network 130, and a verification site 150.

System 300 is very similar to system 100 depicted in FIG. 1, but with no partner site 140. Profiled individuals 110 using system 300 directly access the verification site 150, and provide it with specifics regarding the information to be verified/obtained, as well as the requisite registration, authorization, payment, etc. Searchers 120 then can access the verified information directly on the verification site 150. In one embodiment, each profiled individual 110 may have a separate web-page which reflects her verified information. Such a system 300 may be used in several contexts, including when the contact between the parties is not initiated on an online site. For instance, two people might initially meet in a bar or a dance club, etc., and then wish to provide each other with the Uniform Resource Locator (URL) of the web-page on which their verified information is available. This web-page, in one embodiment, is on the verification site 150. In one embodiment, the verification site 150 may incorporate into itself the functionality of online facilitation site as well, thus rendering a separate partner site 140 unnecessary.

Another example where system 300 may be used is in the context of an employment situation. A potential employee may provide an employer with her resume, along with the URL of her web page on the verification site 150. The employer can then access the verification site 150 to ensure the accuracy of the information stated on the resume. In another embodiment, the potential employee can simply print out a copy of the information from the verification site 150 and submit it along with his resume. In such a situation, the printed copy includes a certification (i.e., indication of verification) that the information has been verified. In yet another embodiment, an employment or job search site can partner with the verification site 150 to verify the educational background etc., of various people who have posted their resumes on the employment partner site.

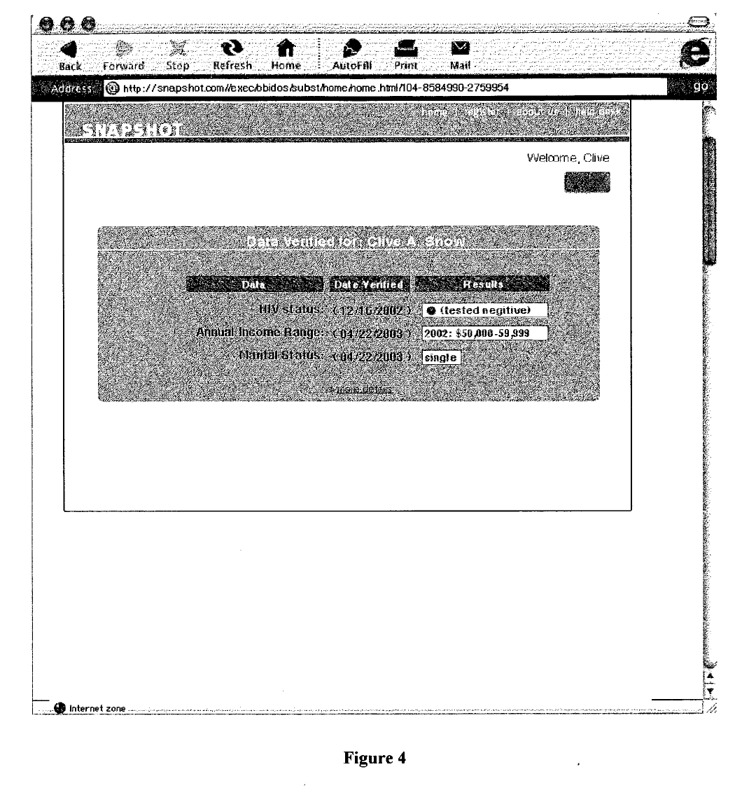

FIG. 4 is a screen shot illustrating what a searcher 120 might see, in one embodiment, upon entering the URL provided by a profiled individual 110. This is an example of a profiled individual's 110 verified data as it may be seen on the verification site 150. It can be seen that clicking on the link labeled “more details” will provide further details relating to the profiled individual 110.

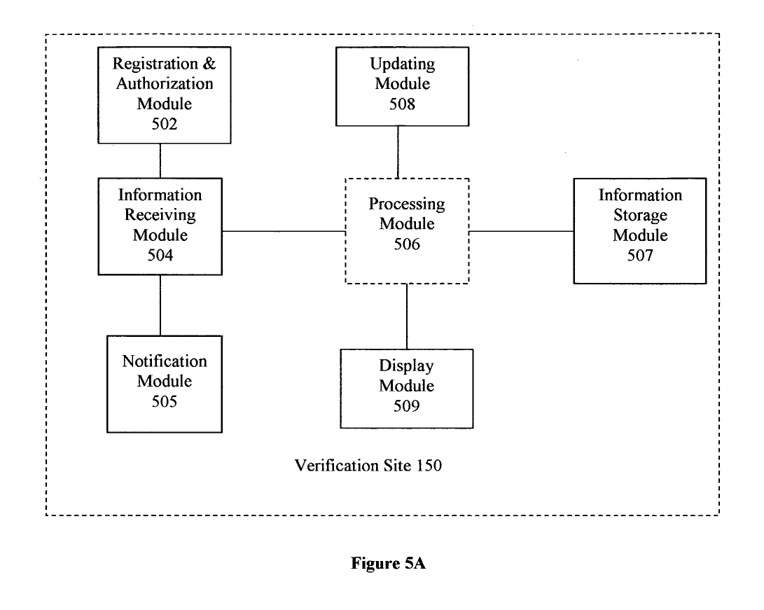

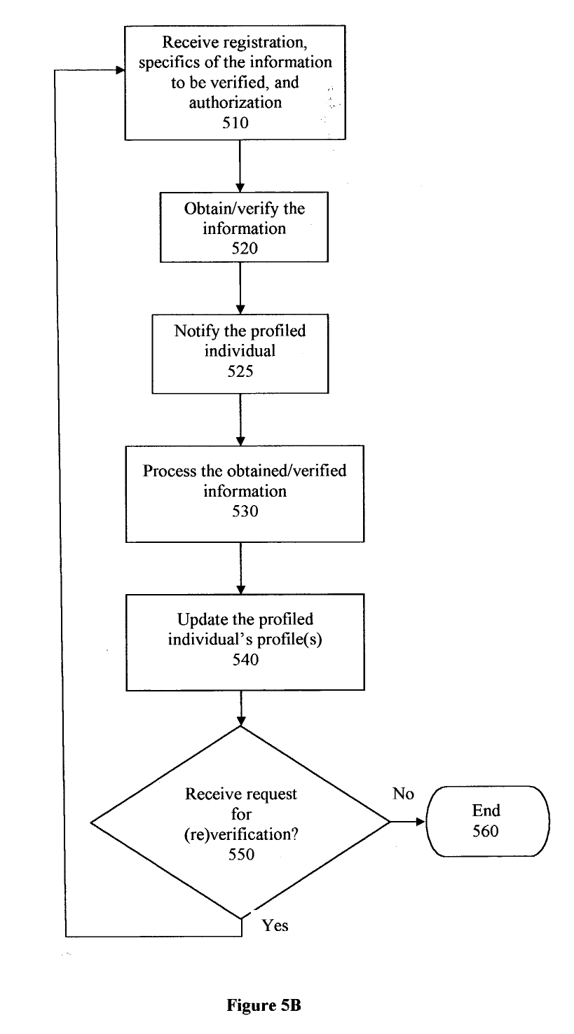

FIG. 5A is a block diagram showing an exploded view of the verification site 150. The verification site 150 comprises of an authorization and registration module 502, an information receiving module 504, a notification module 505, a processing module 506, an information storage module 507, an updating module 508, and a display module 509. The functioning of these modules is explained with reference to FIG. 5B.

FIG. 5B is a flowchart illustrating the functioning of the verification site 150 in accordance with an embodiment of the present invention. As can be seen from FIG. 5B, the registration and authorization module 502 receives 510 the registration from the profiled individual, specifics of the information to be verified, and authorization to verify the information. In one embodiment, when a profiled individual 110 uses the verification site 150 for the first time, he selects the new registration option from the navigation bar or by using a button. The profiled individual 110 then enters the secure portion of the verification site 150. The profiled individual 110 fills out a registration form containing the specifics of the information to be verified, as well as any data necessary for verifying the information. In one embodiment, the profiled individual 110 fills out this registration form on a partner site 140. In one embodiment, the profiled individual 110 fills out this registration form directly on the verification site 150. In addition, the verification site 150 also receives 510 authorization from the profiled individual 110 to verify (or obtain) the specified information. Furthermore, in some embodiments, the verification site 150 receives payment from the profiled individual 110.

In one embodiment, identity validation is required from the profiled individual 110. In one embodiment, electronic identity validation is available, and the profiled individual 110 can use it to submit the registration form online. In another embodiment, electronic identity validation is not available, and the profiled individual 110 needs to print out, sign, and mail/fax the registration form. Once the registration/authorization is completed, in one embodiment, a registration confirmation page appears for the profiled individual's 110 records.

The information receiving module 504 then receives verified and/or obtained 520 requisite information. In one embodiment, the profiled individual 110 states the information (e.g., STD check performed on<date>; test results negative), and the verification site 150 verifies that the information provided is accurate. In another embodiment, the profiled individual 110 merely specifies the information he would like verified (e.g., information relating to HIV tests) and the verification site 150 obtains the information from a third party. As an example of such a situation, a profiled individual 110 may not have tested himself for STDs, but may wish to do so. He provides the verification site 150 with information regarding where he is planning to have himself tested. The verification site 150 then contacts the specified testing center and obtains the results directly. In one embodiment, the verification site 150 may aid the profiled individual 110 further by providing him with recommendations regarding testing centers where such tests can be performed, etc.

Once the information has been verified/obtained 520, in one embodiment, the profiled individual 110 is notified 525 by the notification module 505. Such a notification 525 occurs, in one embodiment, by sending the profiled user 110 an e-mail message at the address provided during registration. The e-mail contains a unique URL. Visiting the web-page specified by the URL brings the profiled individual 110 to a log-in page. Upon logging in, the profiled individual 110 can see the results of the verification 520. In one embodiment, the profiled individual 110 can specify at this time to which partner sites 140 the verified information should be made available. In another embodiment, the profiled individual 110 can specify the desired partner sites 140 during the registration process itself. In yet other embodiments, this specification can be made by the profiled user 110 at other times during the process. Further, in some embodiments, partner sites 140 initially chosen by the profiled individual 110 may be added to or modified at various stages in the process.

This verified/obtained information is then processed 530 by the processing module 506. In one embodiment, the processing 530 includes making the verified/obtained information suitable for presentation on the particular partner site where the profile of the profiled individual 110 is hosted. Different partner sites may have different ways in which the verification is indicated. In one embodiment, a profiled individual 110 may have a profile on a single partner site 140. In another embodiment, a profiled individual 110 may have profiles on various different partner sites 140. In such a situation, the processing 530 of the verified/obtained information may include preparing the information for presentation in several different user interfaces.

In some embodiments, the information may be stored in an information storage module 507.

In one embodiment, the profiled individual's 110 profile(s) is updated 540 by the updating module 508 based on the processed information. An updated profile includes a certification (i.e., some kind of indication) that certain information has been verified. In one embodiment, the certification includes some language (e.g., “Verified by <company name>”), or a symbol indicating verification, for each piece of information that has been verified. In another embodiment, the certification can include a color code (e.g., red if the information provided is inaccurate, green if the information provided is accurate, etc.). It is to be noted that indications of verification can be provided in several other ways.

In one embodiment, the updated profile is displayed by the display module 509. In one embodiment, the updated profile is displayed on the verification site 150 itself. In another embodiment, the updated profile is displayed on the partner site 140.

If a request for re-verification and/or verification of additional information is not received 550, the process ends 560. If such a request is received 550, the process is repeated.

In one embodiment, the verification data is re-verified to ensure accuracy and currentness of the verified data. These re-verifications could occur at certain prespecified time intervals, or when requested by the profiled individual 110.

In one embodiment, when a profiled individual 110 who has used the verification site 150 previously returns to the verification site 150, he logs in as an existing customer. He then enters the secure portion of the verification site 150. His registration and authorization forms are presented to the profiled individual 110. Since he is a returning customer, these forms are largely pre-populated. The profiled individual 110 can then request re-verification of previously verified information, and/or request verification of some other information. In one embodiment, identity validation is required from the returning profiled user 110. As discussed above, the identity validation can be done electronically, or via mail/fax. Finally, a registration confirmation reflecting any changes appears for the profiled individual's 110 records.

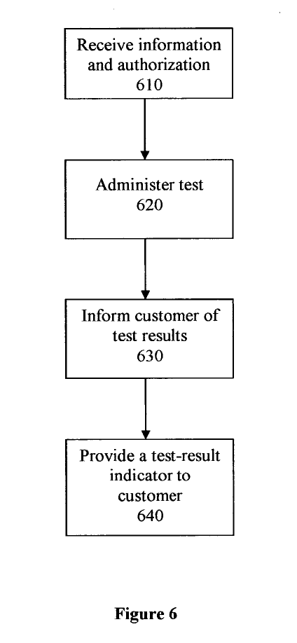

It is to be noted that the present invention is not limited to social relationships, but rather applies to other types of relationships as well, such as employment relationships, etc. It is also to be noted that the present invention is not limited to the initiation and/or maintenance of relationships on-line. FIG. 6 illustrates an embodiment which can be used for HIV testing when social relationships are initiated at a physical location, for example, at a dance club.

The individual who wants his information verified (henceforth referred to as the customer) approaches the verification area. In one embodiment, the verification area may comprise of an area within (or in the vicinity of) a dance club which sectioned-off for purposes of conducting the verification. When the customer enters the verification area, his information, as well as authorization to conduct the tests, are received 610. In one embodiment, the received information is inputted into a database (e.g., a Customer Relationship Management System). In one embodiment, a payment is also received from the customer.

The HIV test is then administered 620 to the customer. Necessary equipment for conducting the HIV test and obtaining the results, as well as technicians to conduct the test are available in the verification area. In one embodiment, a rapid HIV test is conducted, wherein results can be obtained within 20 minutes. In one embodiment, the customer waits in the verification area until the results are available.

It is to be noted that, in one embodiment, physical facilitation sites such as dance clubs, could also partner with the verification site 150 to verify information, rather than conducting HIV tests on-site. In some such embodiments, people wanting results verified at a physical site need to subscribe to the verification site 150 and get tests done ahead of time. The results of the tests are then already included in the verification site 150 by the time the customer wants an indicator of verification. At the physical site, the customer will need to verify his identity, and based on this identity, the individual's profile is obtained from the verification site 150.

Once the results of the test are available, the customer is informed 630 of the results. In one embodiment, a technician discusses the results with the customer is a private room.

The customer is the provided 640 with an indicator of the test results. In one embodiment, the indicator is external and is an accessory which shows the test results. In one embodiment, such accessories are not removable from the customer (or exchangeable) without destruction or visible modification of the accessories. An example of such an accessory is a wristband. In one embodiment, the wrist bands could be of different colors, based on what the test results are. Such an outward indicator also includes, in one embodiment, some identification of the customer (e.g., a photograph, fingerprint(s), bio-identifiers, etc.). In one embodiment, the photograph is taken at the verification area itself. In one embodiment, the indicator also includes other information about the customer (e.g., name, age, etc.). The customer can then go to the dance club (or other physical facilitation site) displaying the indicator.

As will be understood by those familiar with the art, the invention may be embodied in other specific forms without departing from the spirit or essential characteristics thereof. For example, the interaction may be initiated on an online dating site, or elsewhere, such as in dance clubs, etc. Further, the entity who desires the information to be verified may be a corporation, group of people, etc., rather than being an individual. Likewise, the particular capitalization or naming of the modules, protocols, features, attributes, data structures, or any other aspect, is not mandatory or significant, and the mechanisms that implement the invention or its features may have different names or formats. Accordingly, the disclosure of the present invention is intended to be illustrative, but not limiting, of the scope of the invention, which is set forth in the following claims.

What is claimed is:

1. A method for indicating verification of information regarding an entity for purposes of enabling informed relationship decisions, wherein the information to be verified is included in an on-line profile for the entity, the method comprising:
receiving authorization from the entity to verify the information;
receiving verification of the information based on the received authorization; and
updating the on-line profile for the entity by providing an indication of the verification of the information.

2. The method of claim 1, further comprising:
notifying the entity of the verification.

3. The method of claim 1, further comprising:
processing the verified information to make it suitable for presentation on the entity's on-line profile.

4. The method of claim 1, further comprising:
receiving registration from the entity.

5. The method of claim 1, wherein the updating of the on-line profile for the entity by providing an indication of the verification of the information comprises:
inserting an icon adjacent to the verified information in the entity's on-line profile.

6. The method of claim 1, wherein the updating the on-line profile for the entity by providing an indication of the verification of the information comprises:
color coding the verified information in the entity's on-line profile.

7. The method of claim 1, wherein the entity is an individual desiring social interaction.

8. The method of claim 1, wherein the information to be verified relates to a Human Immuno-Deficiency Virus (HIV) test for the individual.

9. The method of claim 1, wherein the information to be verified relates to genotype information.

10. The method of claim 1, wherein the information to be verified relates to phenotype information.

11. The method of claim 1, wherein the entity is an individual seeking employment.

12. The method of claim 1, wherein the on-line profile of the entity is hosted on an interaction facilitation web-site.

13. The method of claim 1, wherein the on-line profile of the entity is hosted on an on-line facilitation site for social interaction.

14. A method for indicating verification of information regarding an entity for purposes of enabling informed relationship decisions, wherein the information to be verified is included in a profile for the entity, the method comprising:
receiving authorization from the entity to verify the information;
receiving verification of the information based on the received authorization; and
updating the profile for the entity by providing an indication of the verification of the information.

15. The method of claim 14, further comprising:
notifying the entity of the verification.

16. The method of claim 14, further comprising:
processing the verified information to make it suitable for presentation on the entity's profile.

17. The method of claim 14, further comprising:
receiving registration from the entity.

18. The method of claim 14, wherein the updating of the profile for the entity by providing an indication of the verification of the information comprises:
inserting an icon adjacent to the verified information in the entity's profile.

19. The method of claim 14, wherein the updating the profile for the entity by providing an indication of the verification of the information comprises:
color coding the verified information in the entity's profile.

20. The method of claim 14, wherein the entity is an individual desiring social interaction.

21. The method of claim 14, wherein the information to be verified relates to a Human Immuno-Deficiency Virus (HIV) test for the individual.

22. The method of claim 14, wherein the information to be verified relates to genotype information.

23. The method of claim 14, wherein the information to be verified relates to phenotype information.

24. The method of claim 14, wherein the entity is an individual seeking employment.

25. A method for indicating verification of information regarding an entity for purposes of enabling informed relationship decisions, the method comprising:
receiving authorization from the entity to obtain the information;
receiving the information based on the received authorization; and
updating the profile for the entity by including the received information, as well as providing an indication of the verification of the information.

26. The method of claim 25, further comprising:
notifying the entity of the obtained information.

27. The method of claim 25, wherein the updating of the profile for the entity comprises:
inserting an icon adjacent to the obtained information in the entity's profile.

28. The method of claim 25, wherein the updating of the profile comprises:
color coding the obtained information in the entity's profile.

29. The method of claim 25, wherein the entity is an individual desiring social interaction.

30. The method of claim 25, wherein the information to be obtained relates to a Human Immuno-deficiency Virus (HIV) test for the individual.

31. The method of claim 25, wherein the information to be obtained relates to genotype information.

32. The method of claim 25, wherein the information to be obtained relates to phenotype information.

33. The method of claim 25, wherein the entity is an individual seeking employment.

34. A method for indicating verification of information regarding an individual for purposes of enabling informed social relationship decisions, wherein the verified information is included in an on-line profile for the individual, where the on-line profile is on a social interaction facilitation site, the method comprising:
receiving authorization from the individual to verify the information;
receiving verification of the information based on the received authorization; and
updating the on-line profile for the individual on the social interaction facilitation site by providing an indication of the verification of the information.

35. A method for indicating verification of HIV test results for an individual for purposes of enabling informed relationship decisions, wherein the HIV test results are included in an on-line profile for the individual, the method comprising:
receiving authorization from the individual to verify the individual's HIV test results;
receiving verification of the individual's HIV test results based on the received authorization; and
updating the on-line profile for the individual by providing an indication of the verification of the HIV test results.

36. The method of claim 35, wherein the HIV test results for the individual include the date on which the HIV tests were conducted.

37. The method of claim 35, wherein the on-line profile is on a social interaction facilitation site.

38. The method of claim 35, further comprising:
receiving a search over a plurality of on-line profiles, using a criterion based on verified HIV test results, wherein the plurality includes the individual's on-line profile.

39. A method for indicating verification of HIV test results for an individual for purposes of enabling informed relationship decisions, the method comprising:
receiving authorization from the individual to obtain the individual's HIV test results;
receiving the individual's HIV test results based on the received authorization; and
updating the profile for the entity by including the HIV test results and providing an indication of the verification of the HIV test results.

40. The method of claim 39, wherein the HIV test results for the individual include the date on which the HIV tests were conducted.

41. The method of claim 39, wherein the profile is on a social interaction facilitation site.

42. A method for indicating verification of information regarding an individual for purposes of enabling informed relationship decisions, the method comprising:
receiving authorization from the individual to obtain the information;
obtaining the information based on the received authorization; and
providing the individual with an indicator of the obtained information.

43. The method of claim 42, wherein the obtained information comprises HIV test results.

44. The method of claim 42, wherein the obtaining of information comprises:
administering an HIV test; and
obtaining the results of the HIV test.

45. The method of claim 42, wherein:
the obtaining of information comprises
administering an HIV test; and
obtaining the results of the HIV test; and the method further comprises:
notifying the individual of the results of the HIV test.

46. The method of claim 42 wherein the obtaining of information comprises:
providing an on-line verification site with the individual's identity; and
obtaining information from the verification site based on the provided identity.

47. The method of claim 42 further comprising:
verifying the individual's identity.

48. The method of claim 42, wherein the indicator is provided to the individual no more than a day prior to the desired usage of the indicator.

49. The method of claim 42, wherein the indicator is an external indicator which cannot be removed from the individual without visible modification of the indicator.

50. The method of claim 42, wherein the indicator is a bracelet.

51. The method of claim 42, wherein the indicator includes identification of the individual.

52. The method of claim 42, wherein the indicator includes identification of the individual, the identification comprising a photograph of the individual.

53. A system indicating verification of information regarding an entity for purposes of enabling informed relationship decisions, wherein the information to be verified is included in an on-line profile for the entity, the system comprising:
an authorization module for receiving authorization from the entity to verify the information;
an information receiving module coupled to the authorization module for receiving the information; and
an updating module coupled to information receiving module for updating the on-line profile for the entity by providing an indication of the verification of the information.

54. A computer program product readable by a machine, embodying a program of instructions executable by the machine to perform a method for indicating verification of information regarding an entity for purposes of enabling informed relationship decisions, wherein the information to be verified is included in an on-line profile for the entity, the method comprising:
receiving authorization from the entity to verify the information;
receiving verification of the information based on the received authorization; and
updating the on-line profile for the entity by providing an indication of the verification of the information.
